(19) United States
(12) Patent Application Publication
(10) Pub. No.: US 2015/0290075 A1
(43) Pub. Date: Oct. 15, 2015

(54) THYMUS NECKLACE

(71) Applicant: Adnan ÇALISIR, (US)

(72) Inventor: Adnan Çalisir, Gaziemir/Izmir (TR)

(21) Appl. No.: 14/441,278

(22) PCT Filed: Nov. 6, 2013
(86) PCT No.: PCT/TR2013/000340

§ 371 Date: May 7, 2015

(30) Foreign Application Priority Data
Nov. 8, 2012 (TR) 2012/12883

(51) Int. Cl. A61H 23/00; A44C 25/00; A44C 15/00

(52) U.S. Cl. CPC A61H 23/00; A44C 15/005; A44C 25/001

(57) ABSTRACT

A necklace for activating the thymus gland has a vibration mechanism with a vibration motor, a power source and an on/off button.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention is related with a necklace that is designed for actuating the Thymus Gland.

2. Description of Related Art Including Information Disclosed Under 37 CFR 1.97 and 37 CFR 1.98.

The Thymus Gland is found under the Thyroid Gland, in the chest cavity and in front of the trachea. The Thymus Gland, both pre and after the birth, produces lymphocyte and protects the body from the infections. The T cells that the Thymus produces are one of the most beneficial cells for health. The lymphocytes that are named as T cells eliminate the harmful cells that damage the body. When the T cells cease the communication lines, the fatal illnesses collapse the immune system and the Thymus Gland loses its function in time, thus, this case causes the immune system to be deteriorated and sickness. There are three things that activate the Thymus Gland: to vibrate the point on the Thymus Gland with two fingers, to make the tongue touch the palate behind the upper teeth and the roof of the mouth and to guggle. When the Thymus is stimulated it excretes lymphocytes that enhance the immune system, therefore the person relaxes both physically and psychologically.

There is not any inventory technique that stimulates the Thymus Gland by an external impact.

### BRIEF SUMMARY OF THE INVENTION

The aim is to enhance the immune system and make the person relax by producing lymphocyte, also known as T cell by actuating the vibration motor that gets energy from the power source by turning on the on/off button on the necklace safeguard, making the necklace safeguard and thus the Thymus Gland vibrate. When the person physically and psychologically feels negative, instead of vibrating the point on the Thymus Gland with two fingers or implementing the other methods, turning on the necklace when needed will be sufficient to actuate the Thymus Gland. The figures below show the necklace that is produced for its aim.

### BRIEF DESCRIPTION OF THE DRAWINGS

FIG. 1: The interior view of the Thymus Necklace

FIG. 2: The view of the Thymus Necklace and the Thymus Gland.

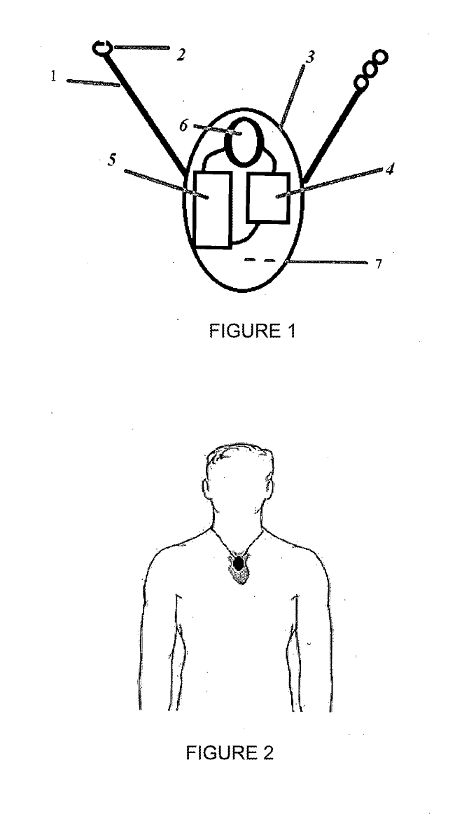

The description of the references on the figure

The parts of the figures are numerated and explained below:

1: The chain

2: The hook that fits the size of the chain

3: Necklace safeguard

4: Vibration motor

5: Power source

6: Turn on/off button

7: Locking element

### DETAILED DESCRIPTION OF THE INVENTION

The invention is composed of seven parts that are; the vibration motor (4) found in the necklace safeguard (3) providing the vibration, power source (5), turn on/off button (6), the chain (1) of the necklace safeguard (3),the hook that fits the size of the chain (2) and the locking element (7) for fixing necklace on the thymus. The necklace safeguard (3) is placed on the Thymus Gland of a person by fitting the size of the chain (2) by the hook. When the person physically and physiologically feels negative or when needed, the necklace will be activated by turning on the on/off button (6) and providing the vibration motor (4) to get energy from the power source (5) and the Thymus Gland will be activated by the vibration that the necklace provides.

### THE INDUSTRIAL IMPLEMENTATION OF THE INVENTION

The Thymus Necklace explained above can be produced and applicable to the industry.

1. A necklace for activating the Thymus Gland comprises a vibration mechanism composed of a vibration motor, a power source and an on/off button.

2. The necklace for activating the Thymus Gland of claim 1, having a vibration mechanism composed of a vibration motor, a power source and a turn on/off button and replaced in a necklace safeguard.

3. The necklace for activating the Thymus Gland of claim 2, wherein the necklace safeguard that covers the vibration mechanism inside can be fitted by a chain and a hook that fit the size of the chain to be replaced on the Thymus Gland.

4. The necklace for activating the Thymus Gland of claim 3, wherein the necklace safeguard that covers the vibration mechanism inside can be fixed by a locking element on the Thymus Gland.
